(19) United States
(12) Patent Application Publication
(10) Pub. No.: US 2026/0327460 A1
(43) Pub. Date: Oct. 22, 2026

(54) ADHESIVE FILM

(71) Applicant: 3M INNOVATIVE PROPERTIES COMPANY, St. Paul, MN (US)

(72) Inventor: Hidetoshi Abe, Tokyo (JP)

(21) Appl. No.: 19/115,000

(22) PCT Filed: Oct. 16, 2023
(86) PCT No.: PCT/IB2023/060421

§ 371 Date: Mar. 25, 2025

(30) Foreign Application Priority Data
Oct. 27, 2022 (JP) 2022-172135

(51) Int. Cl. C09J 7/38; C09J 11/04; C09J 11/08; C09J 133/02

(52) U.S. Cl. CPC C09J 7/385; C09J 11/04; C09J 11/08; C09J 133/02

(57) ABSTRACT

An adhesive film that can be adhered to various three-dimensional surfaces, such as rough surfaces, curved surfaces, and corner portions, and that can provide an excellent metallic appearance. The adhesive film includes a clear film layer and an acrylic pressure-sensitive adhesive layer and has a metallic appearance. The acrylic pressure-sensitive adhesive layer includes an acrylic adhesive polymer and a resin-coated metal pigment, a glass transition temperature of the acrylic adhesive polymer is −25° C. or lower, and the acrylic pressure-sensitive adhesive layer contains from 5 parts by mass to 100 parts by mass of the resin-coated metal pigment relative to 100 parts by mass of the acrylic adhesive polymer.

### TECHNICAL FIELD

The present disclosure relates to an adhesive film.

### BACKGROUND

Adhesive films with metallic appearance have been widely used in, for example, markings on vehicles, ships, and aircraft, interior and exterior of buildings, and illuminated signs. Such an adhesive film is typically a laminate including a film layer and a pressure-sensitive adhesive layer, and has a structure in which the film layer, the pressure-sensitive adhesive layer, or another optional intermediate layer contains a metallic pigment, or a metal layer such as metal plating, a metal-deposited film, or a metal foil is arranged on top of the surface of the film layer or in between the layers constituting the adhesive film.

Patent Document 1 (JP 2006-088593 A) describes “a metallic adhesive sheet for decoration obtained by laminating an acrylic resin layer (A) containing a UV absorbing agent and having a total light transmittance of visible light of 85% or greater, a metallic adhesive layer (B) obtained by blending an aluminum metal powder and a pearl pigment in an acrylic adhesive agent, a soft vinyl chloride resin layer (C) that is colored, and an acrylic adhesive layer (D), in this order”.

### SUMMARY OF INVENTION

In many cases, a surface to which an adhesive film is adhered, such as an interior wall or exterior wall of a building, is a rough surface. The adhesive film may be adhered to a flat surface but it may also be adhered in such a manner that the adhesive film covers a curved surface or a corner portion.

The present disclosure provides an adhesive film that can be adhered to various three-dimensional surfaces, such as rough surfaces, curved surfaces, and corner portions, and that can provide an excellent metallic appearance.

An ordinary metallic pigment used to impart a metallic appearance, such as an aluminum pigment, has low compatibility with a pressure-sensitive adhesive. The inventors of the present disclosure found that the metallic pigment having a resin coating has excellent compatibility with a pressure-sensitive adhesive and can maintain adhesiveness and elongation properties while metallic appearance is imparted to a pressure-sensitive adhesive layer.

According to an embodiment, an adhesive film having a metallic appearance, the adhesive film including a clear film layer and an acrylic pressure-sensitive adhesive layer, the acrylic pressure-sensitive adhesive layer including an acrylic adhesive polymer and a resin-coated metal pigment, the acrylic adhesive polymer having a glass transition temperature of −25° C. or less, and the acrylic pressure-sensitive adhesive layer containing from 5 parts by mass to 100 parts by mass of the resin-coated metal pigment relative to 100 parts by mass of the acrylic adhesive polymer is provided.

According to the present disclosure, an adhesive film that can be adhered to various three-dimensional surfaces, such as rough surfaces, curved surfaces, and corner portions, and that can provide an excellent metallic appearance is provided.

Note that the above description is not construed as disclosure of all of embodiments of the present invention and advantages related to the present invention.

### BRIEF DESCRIPTION OF THE DRAWING

FIG. 1 is a schematic cross-sectional view of an adhesive film according to an embodiment of the present disclosure.

### DESCRIPTION OF EMBODIMENTS

Hereinafter, the present invention will be described in more detail with reference to the drawings for the purpose of illustrating representative embodiments of the present invention, but the present invention is not limited to these embodiments.

In the present disclosure, the term “(meth)acrylic” refers to acrylic or methacrylic, and the term “(meth)acrylate” refers to acrylate or methacrylate.

In the present disclosure, the term “film” encompasses articles referred to as “sheets”.

In the present disclosure, “pressure-sensitive adhesive (ness)” refers to the characteristic of a material or composition that the material or composition adheres to various surfaces with just light pressure for a short time in the temperature range of usage, such as from 0° C. to 50° C., and does not exhibit a phase change (from liquid to solid). In the present disclosure, “adhesive (ness)” is used interchangeably with “pressure-sensitive adhesive (ness)”.

An adhesive film of an embodiment has a clear film layer and an acrylic pressure-sensitive adhesive layer and has a metallic appearance. The acrylic pressure-sensitive adhesive layer includes an acrylic adhesive polymer and a resin-coated metal pigment. The resin-coated metal pigment imparts a metallic appearance, which is visible through the clear film layer of the adhesive film, to the acrylic pressure-sensitive adhesive layer.

The clear film layer and the acrylic pressure-sensitive adhesive layer may be in a direct contact, or another layer, such as a colored layer, a printed layer, or a bulk layer, may be interposed between these layers. On the clear film layer, another layer, such as a colored layer, a printed layer, a bulk layer, or a surface-protecting layer, may be laminated. The adhesive film may further include another functional layer such as a primer layer that enhances adhesive properties of the clear film layer and the acrylic pressure-sensitive adhesive layer. A surface that is in contact with the acrylic pressure-sensitive adhesive layer of the clear film layer may be subjected to a surface treatment, such as corona treatment and plasma treatment.

The adhesive film may include a liner on the surface of the acrylic pressure-sensitive adhesive layer, the surface being on an opposite side of the clear film layer. Examples of the liner, which is an optional component, include plastic materials such as polyethylenes, polypropylenes, polyesters, and cellulose acetates, papers, and laminated papers coated with such plastic materials. These liners may have a surface that has been subjected to release-liner treatment with silicone or the like. The thickness of the liner can be typically approximately 10 μm or greater, or approximately 25 μm or greater, and approximately 500 μm or less, or approximately 200 μm or less.

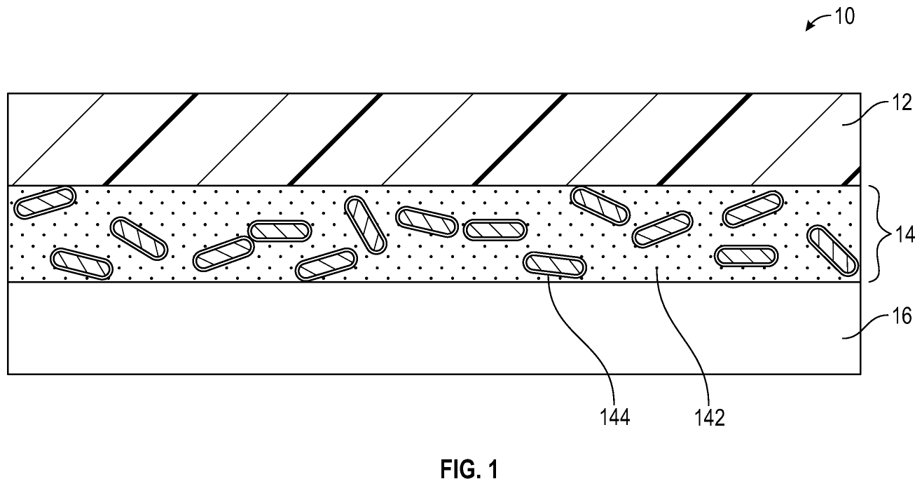

FIG. 1 illustrates a schematic cross-sectional view of an adhesive film of an embodiment. The adhesive film 10 has a clear film layer 12, an acrylic pressure-sensitive adhesive layer 14 and, optionally, a liner 16. The acrylic pressure-sensitive adhesive layer 14 includes an acrylic adhesive polymer 142 and resin-coated metal pigments 144 dispersed in the acrylic adhesive polymer 142.

As the clear film layer, for example, plastic films, such as polyethylene films, polypropylene films, polyester films, acrylic resin films, polycarbonate films, polyvinyl chloride films, polyvinylidene chloride films, polyurethane films, polystyrene films, and polyamide films, can be used.

Various thicknesses can be employed for the clear film layer and, for example, the thickness can be approximately 5 μm or greater, approximately 10 μm or greater, or approximately 20 μm or greater, and approximately 500 μm or less, approximately 300 μm or less, or approximately 200 μm or less.

In an embodiment, the visible light transmittance of the clear film layer is approximately 70% or greater, approximately 80% or greater, or approximately 90% or greater. In the present disclosure, “visible light transmittance” refers to an average visible light transmittance in the wavelength of 380 nm to 780 nm measured in accordance with JIS A 5759:2008.

The acrylic pressure-sensitive adhesive layer includes an acrylic adhesive polymer and resin-coated metal pigments.

The acrylic adhesive polymer can be obtained by polymerizing or copolymerizing a polymerizable composition containing a (meth)acrylic monomer and, as necessary, a monomer having another monoethylenic unsaturated group. In the present disclosure, a (meth)acrylic monomer and a monomer having another monoethylenic unsaturated group are collectively referred to as polymerizable components. The (meth)acrylic monomer and the monomer having another monoethylenic unsaturated group may be used in a combination of one type alone, or in combination of two or more types.

The (meth)acrylic monomer typically includes an alkyl (meth)acrylate. The number of carbon atoms of the alkyl group of the alkyl (meth)acrylate may be from 1 to 12. Examples of the alkyl (meth)acrylate include straight-chain or branched alkyl (meth)acrylate, such as methyl (meth)acrylate, ethyl (meth)acrylate, n-butyl (meth)acrylate, isobutyl (meth)acrylate, 2-methylbutyl (meth)acrylate, isoamyl (meth)acrylate, n-hexyl (meth)acrylate, n-octyl (meth)acrylate, isooctyl (meth)acrylate, 2-ethylhexyl (meth)acrylate, n-nonyl (meth)acrylate, isononyl (meth)acrylate, n-decyl (meth)acrylate, isodecyl (meth)acrylate, and n-dodecyl (meth)acrylate; and alicyclic (meth)acrylate, such as cyclohexyl (meth)acrylate, 4-t-butylcyclohexyl (meth)acrylate, and isobornyl (meth)acrylate. The alkyl (meth)acrylate preferably includes methyl acrylate, n-butyl acrylate, 2-methylbutyl acrylate, 2-ethylhexyl acrylate, isooctyl acrylate, or a combination of these.

The alkyl (meth)acrylate forms a main component of the acrylic adhesive polymer. In an embodiment, the acrylic adhesive polymer is obtained by copolymerizing a polymerizable composition containing the alkyl (meth)acrylate in an amount of approximately 50 mass % or greater, approximately 70 mass % or greater, or approximately 80 mass % or greater, and approximately 99.5 mass % or less, approximately 99 mass % or less, or approximately 98 mass % or less, with respect to the mass of the polymerizable components, and includes structural units derived from the alkyl (meth)acrylate in the mass ratio described above.

The (meth)acrylic monomer may include aromatic (meth)acrylate such as phenyl (meth)acrylate and p-tolyl (meth)acrylate; phenoxy alkyl (meth)acrylate such as phenoxy ethyl (meth)acrylate; alkoxy alkyl (meth)acrylate such as methoxypropyl (meth)acrylate and 2-methoxybutyl (meth)acrylate; or cyclic ether-containing (meth)acrylate such as glycidyl (meth)acrylate or tetrahydrofurfuryl (meth)acrylate.

The (meth)acrylic monomer or the monomer having another monoethylenic unsaturated group may include a polar monomer that is copolymerizable with the alkyl (meth)acrylate. Examples of the polar monomer include carboxy group-containing monomers such as (meth)acrylic acid, phthalic acid monohydroxyethyl (meth)acrylate, β-carboxyethyl (meth)acrylate, 2-(meth)acryloyloxyethyl succinic acid, 2-(meth)acryloyloxyethyl hexahydrophthalic acid, crotonic acid, itaconic acid, fumaric acid, citraconic acid, and maleic acid; amino group-containing monomers, including aminoalkyl (meth)acrylate such as aminoethyl (meth)acrylate, monoalkylaminoalkyl (meth)acrylate such as butylaminoethyl (meth)acrylate, dialkylaminoalkyl (meth)acrylate such as N,N-dimethylaminoethyl acrylate (DMAEA) and N,N-dimethylaminoethyl methacrylate (DMAEMA), dialkylaminoalkyl (meth)acrylamide such as N,N-dimethylaminopropyl acrylamide (DMAPAA) and N,N-dimethylaminopropyl methacrylamide, and dialkylaminoalkyl vinyl ether such as N,N-dimethylaminoethyl vinyl ether and N,N-diethylaminoethyl vinyl ether; amide group-containing monomers such as (meth)acrylamide, N-vinylpyrrolidone, and N-vinylcaprolactam; hydroxy group-containing monomers such as 2-hydroxyethyl (meth)acrylate, 2-hydroxypropyl (meth)acrylate, and 4-hydroxybutyl (meth)acrylate; and unsaturated nitrile such as (meth)acrylonitrile. These polar monomers can enhance adhesive strength by enhancing cohesive force of the adhesive layer.

Examples of the monomer having another monoethylenic unsaturated group include aromatic vinyl monomers such as styrene, α-methylstyrene, and vinyl toluene; and vinyl esters such as vinyl acetate.

The acrylic adhesive polymer is preferably a carboxy group-containing (meth)acrylic polymer. The carboxy group-containing (meth)acrylic polymer can be obtained by copolymerizing a polymerizable composition containing a carboxy group-containing monomer as a polymerizable component. The carboxy group-containing (meth)acrylic polymer can enhance adhesive strength by enhancing cohesive force by the presence of the carboxy group. The carboxy group-containing (meth)acrylic polymer may enhance adhesive properties between the clear film layer and the acrylic pressure-sensitive adhesive layer. As the carboxy group-containing monomer, (meth)acrylic acid is preferred.

In an embodiment, the carboxy group-containing (meth)acrylic polymer is obtained by copolymerizing a polymerizable composition containing the carboxy group-containing monomer in an amount of approximately 0.5 mass % or greater, approximately 1 mass % or greater, or approximately 2 mass % or greater, and approximately 15 mass % or less, approximately 10 mass % or less, or approximately 8 mass % or less, relative to the mass of the polymerizable components, and includes structural units derived from the carboxy group-containing monomer in the mass ratio described above.

The polymerization or copolymerization of the acrylic adhesive polymer can be performed by radical polymerization. As the radical polymerization, a known polymerization method can be utilized, such as solution polymerization, suspension polymerization, emulsion polymerization, and bulk polymerization. It is advantageous to use solution polymerization that can easily synthesize a polymer with a high molecular weight. As the polymerization initiator, for example, an organic peroxide such as benzoyl peroxide, lauroyl peroxide, or bis(4-tert-butylcyclohexyl)peroxydicarbonate; or an azo-based polymerization initiator such as 2,2′-azobisisobutyronitrile, 2,2′-azobis(2-methylbutyronitrile), dimethyl-2,2-azobis(2-methylpropionate), 4,4′-azobis(4-cyanovalerianic acid), dimethyl 2,2′-azobis(2-methylpropionate), or azobis(2,4-dimethylvaleronitrile) (AVN) can be used. The used amount of the polymerization initiator is typically approximately 0.01 parts by mass or greater, or approximately 0.05 parts by mass or greater, and approximately 5 parts by mass or less, or approximately 3 parts by mass or less, relative to 100 parts by mass of the polymerizable components.

The glass transition temperature (Tg) of the acrylic adhesive polymer is approximately −25° C. or lower. By setting the glass transition temperature of the acrylic adhesive polymer to approximately −25° C. or lower, pressure-sensitive adhesiveness can be imparted to the acrylic pressure-sensitive adhesive layer at an operating temperature (e.g., from 5° C. to 35° C.) even when a combination with the resin-coated metal pigments in an amount that is adequate to exhibit a metallic appearance is employed. In an embodiment, the glass transition temperature of the acrylic adhesive polymer is approximately −30° C. or lower, or approximately −35° C. or lower. In an embodiment, the glass transition temperature of the acrylic adhesive polymer is approximately −70° C. or higher, approximately −65° C. or higher, or approximately −60° C. or higher. By setting the glass transition temperature of the acrylic adhesive polymer to approximately −70° C. or higher, adhesive strength and retention strength can be imparted to the pressure-sensitive adhesive layer.

The glass transition temperature (Tg) of the acrylic adhesive polymer can be determined as a calculated glass transition temperature by using the following Fox equation (Fox, T. G., Bull. Am. Phys. Soc., 1 (1956), p. 123) when the polymer is formed by copolymerization of n types of monomers:

### Equation 1:

$$\frac{1}{T g + 273.15} = {\sum }_{i = 1}^{n} ( \frac{{X}_{i}}{T {g}_{i} + 273.15} )$$

In the equation, Tgᵢ represents the glass transition temperature (° C.) of a homopolymer of a component i, Xᵢ represents the mass fraction of the monomer of the component i added during polymerization, and i is a natural number of 1 to n, and

### Equation 2:

$${\sum }_{i = 1}^{n} {X}_{i} = 1$$

In an embodiment, the weight average molecular weight (Mw) of the acrylic adhesive polymer is approximately 150000 or greater, approximately 200000 or greater, or approximately 250000 or greater, and approximately 2000000 or less, approximately 1500000 or less, or approximately 1000000 or less. In the present disclosure, “weight average molecular weight” is a molecular weight in terms of polystyrene standard by the gel permeation chromatography (GPC) method.

The resin-coated metal pigment is a pigment in which at least a part of a surface of a metallic pigment is covered by a resin, and exhibits excellent compatibility with the acrylic adhesive polymer. By using the resin-coated metal pigment, adhesiveness and elongation properties can be maintained while the metallic appearance is imparted to the acrylic pressure-sensitive adhesive layer. The resin-coated metal pigment may be used alone, or a combination of two or more types of the resin-coated metal pigments may be used.

The metal contained in the resin-coated metal pigment is not particularly limited, and examples thereof include aluminum, zinc, iron, magnesium, copper, nickel, and alloys thereof. Because metallic luster can be effectively provided with a smaller used amount and because of the low price, the resin-coated metal pigment preferably contains aluminum.

The raw material constituting the resin coating of the resin-coated metal pigment is not particularly limited, and examples thereof include acrylic resins, polyolefin, polybutadiene, polyvinyl chloride, polyvinylidene chloride, polyvinyl acetate, fluororesins, polyvinyl ether, polystyrene, and copolymers and blends of these. Because of excellent compatibility with the acrylic adhesive polymer, the resin-coated metal pigment preferably contains the acrylic resin coating.

The resin-coated metal pigment is not particularly limited in terms of its shapes, and is available in the form of, for example, scales, spheres, needles, and lumps. Since the metallic luster can be effectively provided with a smaller used amount, the resin-coated metal pigment is preferably scaly.

In an embodiment, the average particle diameter of the resin-coated metal pigments is approximately 5 μm or greater, approximately 7 μm or greater, or approximately 10 μm or greater, and approximately 70 μm or less, approximately 50 μm or less, or approximately 40 μm or less. By setting the average particle diameter of the resin-coated metal pigments in the range described above, the resin-coated metal pigments can be more uniformly dispersed in the acrylic pressure-sensitive adhesive layer. The average particle diameter of the resin-coated metal pigments is a volume cumulative particle diameter D₅₀ that can be determined by laser diffraction/scattering particle size distribution measurement.

The acrylic pressure-sensitive adhesive layer contains approximately 5 parts by mass or greater and approximately 100 parts by mass or less of the resin-coated metal pigments relative to 100 parts by mass of the acrylic adhesive polymer. By setting the content of the resin-coated metal pigments to approximately 5 parts by mass or greater, a metallic appearance can be imparted to the entire acrylic pressure-sensitive adhesive layer. By setting the content of the resin-coated metal pigments to approximately 100 parts by mass or less, adhesiveness and elongation properties of the acrylic pressure-sensitive adhesive layer can be maintained. In an embodiment, the acrylic pressure-sensitive adhesive layer contains approximately 6 parts by mass or greater, or approximately 8 parts by mass or greater, and approximately 50 parts by mass or less, or approximately 30 parts by mass or less, of the resin-coated metal pigments relative to 100 parts by mass of the acrylic adhesive polymer.

In an embodiment, the content of the pigments other than the resin-coated metal pigments of the acrylic pressure-sensitive adhesive layer is less than approximately 5 parts by mass, less than approximately 3 parts by mass, or less than approximately 1 part by mass, relative to 100 parts by mass of the acrylic adhesive polymer. By setting the content of the pigments other than the resin-coated metal pigments of the acrylic pressure-sensitive adhesive layer to less than approximately 5 parts by mass, the quality of the metallic appearance of the acrylic pressure-sensitive adhesive layer can be enhanced.

The acrylic pressure-sensitive adhesive layer may further include a dispersant that enhances dispersibility of the resin-coated metal pigments in the acrylic adhesive polymer. Examples of the dispersant include low molecular weight dispersants including anionic compounds, cationic compounds, and nonionic compounds, and high molecular weight dispersants having an anionic, cationic, or nonionic polar group. The dispersant may be used alone, or a combination of two or more types of dispersants may be used.

The dispersant preferably has a basic group. The dispersant having a basic group can effectively disperse the resin-coated metal pigments in the acrylic adhesive polymer. In an embodiment where the acrylic adhesive polymer includes a carboxy group-containing (meth)acrylic polymer, the dispersant having a basic group can enhance cohesive force of the acrylic pressure-sensitive adhesive layer by the interaction with the carboxy group-containing (meth)acrylic polymer and, by this, adhesive strength and retention strength of the acrylic pressure-sensitive adhesive layer can be enhanced.

In an embodiment, the low molecular weight dispersant includes at least one type selected from the group consisting of piperidyl compounds and benzotriazole compounds. The piperidyl compound and the benzotriazole compound can further enhance dispersibility of the resin-coated metal pigments. In an embodiment where the acrylic adhesive polymer includes a carboxy group-containing (meth)acrylic polymer, a triazole ring or piperidine ring of the piperidyl compound and the benzotriazole compound can enhance cohesive force of the acrylic pressure-sensitive adhesive layer by the interaction with a carbonyl group of the carboxy group-containing (meth)acrylic polymer and, by this, adhesive strength and retention strength of the acrylic pressure-sensitive adhesive layer can be enhanced.

The piperidyl compound is preferably a piperidyl compound which has at least two piperidyl groups and in which these piperidyl groups are bonded through a divalent linking group having 4 or more, 6 or more, or 8 or more carbon atoms. The piperidyl compound in which piperidyl groups are bonded through a divalent linking group having 4 or more, 6 or more, or 8 or more carbon atoms has excellent miscibility with the acrylic adhesive polymer.

The piperidyl compound may be a piperidyl compound that can be used as a hindered amine light stabilizer (HALS). By using the hindered amine light stabilizer as the piperidyl compound, UV resistance can be imparted to the acrylic pressure-sensitive adhesive layer.

Examples of the piperidyl compound include bis(1,2,2,6,6-pentamethyl-4-piperidyl)sebacate, bis(2,2,6,6-tetramethyl-1-(octyloxy)-4-piperidyl)sebacate, bis(2,2,6,6-tetramethyl-4-piperidyl)sebacate, bis(1,2,2,6,6-pentamethyl-4-piperidyl)-[[3,5-bis(1,1-dimethylethyl)-4-hydroxyphenyl]methyl]butylmalonate, polyester having a terminal capped with dimethyl of butanedioic acid and 4-hydroxy-2,2,6,6-tetramethyl-1-piperidineethanol, tetrakis(1,2,2,6,6-pentamethyl-4-piperidyl)butane-1,2,3,4-tetracarboxylate, and tetrakis(2,2,6,6-tetramethyl-4-piperidyl)butane-1,2,3,4-tetracarboxylate.

The benzotriazole compound is preferably a 2H-benzotriazole compound and, more preferably, a substituted or unsubstituted hydroxyphenyl group is arranged at 2-position. A 2H-benzotriazole compound, especially a 2H-benzotriazole compound having a substituted or unsubstituted hydroxyphenyl group at 2-position, has excellent miscibility with the acrylic adhesive polymer.

The benzotriazole compound may be a benzotriazole compound that can be used as a UV absorbing agent (UVA). By using the benzotriazole compound having UV absorbing properties, UV resistance can be imparted to the acrylic pressure-sensitive adhesive layer.

Examples of the benzotriazole compound include 2-(2H-benzotriazol-2-yl)-p-cresol, 2-(2H-benzotriazol-2-yl)-4-methylphenol, 2-(2H-benzotriazol-2-yl)-4-methyl-6-(straight-chain or branched)dodecylphenol, 2-(2H-benzotriazol-2-yl)-4,6-bis(1-methyl-1-phenylethyl)phenol, 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol, 2,2′-methylene-bis [6-(2H-benzotriazol-2-yl)-4-(1,1,3,3-tetramethylbutyl)phenol], and C7-9 branched or straight-chain alkyl esters of 3-(2H-benzotriazol-2-yl)-5-(1,1-dimethylethyl)-4-hydroxy-benzene propanoic acid.

In an embodiment, the high molecular weight dispersant includes an amino group-containing (meth)acrylic polymer. The amino group-containing (meth)acrylic polymer exhibits excellent miscibility with a (meth)acrylic polymer having an acidic group such as a carboxy group, in addition to enhancing dispersibility of the resin-coated metal pigments. The amino group-containing (meth)acrylic polymer can be obtained by copolymerizing a polymerizable composition containing an amino group-containing monomer as a polymerizable component, among polymerizable composition described for the acrylic adhesive polymer. As the amino group-containing monomer, dialkylamino alkyl (meth)acrylate such as N,N-dimethylaminoethyl acrylate (DMAEA) or N,N-dimethylaminoethyl methacrylate (DMAEMA) is preferred.

In an embodiment, the amino group-containing (meth)acrylic polymer is obtained by copolymerizing a polymerizable composition containing the amino group-containing monomer in an amount of approximately 0.5 mass % or greater, approximately 1 mass % or greater, or approximately 3 mass % or greater, and approximately 20 mass % or less, approximately 15 mass % or less, or approximately 10 mass % or less, relative to the mass of the polymerizable components, and includes structural units derived from the amino group-containing monomer in the mass ratio described above.

In an embodiment, the glass transition temperature (Tg) of the amino group-containing (meth)acrylic polymer is approximately 0° C. or higher, approximately 20° C. or higher, or approximately 40° C. or higher, and approximately 150° C. or lower, approximately 135° C. or lower, or approximately 120° C. or lower. The glass transition temperature of the amino group-containing (meth)acrylic polymer can be determined by using the Fox equation similarly to the acrylic adhesive polymer.

The weight average molecular weight of the amino group-containing (meth)acrylic polymer is not particularly limited and, for example, can be approximately 1000 or greater, approximately 5000 or greater, or approximately 10000 or greater, and approximately 200000 or less, approximately 100000 or less, or approximately 80000 or less.

The content of the dispersant in the acrylic pressure-sensitive adhesive layer can be approximately 10 parts by mass or greater, approximately 20 parts by mass or greater, or approximately 40 parts by mass or greater, and approximately 500 parts by mass or less, approximately 300 parts by mass or less, or approximately 250 parts by mass or less, relative to 100 parts by mass of the resin-coated metal pigments.

The acrylic pressure-sensitive adhesive layer can be formed on the clear film layer, on another layer constituting the laminate having the clear film layer, or on a liner by using the pressure-sensitive adhesive composition containing the acrylic adhesive polymer and the resin-coated metal pigments and, optionally, a dispersant, a crosslinking agent, a solvent, and/or other additives.

The crosslinking agent is not particularly limited as long as the crosslinking agent can form a crosslink between polymer chains of the acrylic adhesive polymer. By using the crosslinking agent, cohesive force of the acrylic pressure-sensitive adhesive layer can be enhanced and, by this, adhesive strength and retention strength of the acrylic pressure-sensitive adhesive layer can be enhanced. For example, in a case where the acrylic adhesive polymer is a carboxy group-containing (meth)acrylic polymer, as the crosslinking agent, an epoxy crosslinking agent, a bisamide crosslinking agent, an aziridine crosslinking agent, a carbodiimide crosslinking agent, or an isocyanate crosslinking agent can be used. The crosslinking agent may be used alone, or a combination of two or more types of crosslinking agents may be used.

Examples of the epoxy crosslinking agent include N,N,N′,N′-tetraglycidyl-1,3-benzenedi(methanamine) (product name: TETRAD-X (Mitsubishi Gas Chemical Company Inc., Chiyoda-ku, Tokyo, Japan), E-AX and E-5XM (both from Soken Chemical & Engineering Co., Ltd., Toshima-ku, Tokyo, Japan)); and N,N′-(cyclohexane-1,3-diylbismethylene)bis(diglycidylamine) (product name: TETRAD-C (Mitsubishi Gas Chemical Company Inc., Chiyoda-ku, Tokyo, Japan), and E-5C (Soken Chemical & Engineering Co., Ltd., Toshima-ku, Tokyo, Japan)).

Examples of the bisamide crosslinking agent include 1,1′-(1,3-phenylenedicarbonyl)bis(2-methylaziridine), 1,4-bis(ethyleneiminocarbonylamino)benzene, 4,4′-bis(ethyleneiminocarbonylamino)diphenylmethane, and 1,8-bis(ethyleneiminocarbonylamino)octane.

Examples of the aziridine crosslinking agent include 2,2-bishydroxymethylbutanol-tris[3-(1-aziridinyl)propionate (trade name: CHEMITITE (registered trademark) PZ-33 (Nippon Shokubai Co., Ltd., Osaka-shi, Osaka, Japan), and Crosslinker CX-100 (DSM Coating Resins B.V., Zwolle, Netherlands)).

Examples of the carbodiimide crosslinking agent include Carbodilite V-03, V-05, and V-07 (all from Nisshinbo Chemical Inc., Chuo-ku, Tokyo, Japan).

Examples of the isocyanate crosslinking agent include Coronate L and Coronate HK (both from Tosoh Corporation, Minato-ku, Tokyo, Japan).

The crosslinking agent can be used in an amount of approximately 0.01 parts by mass or greater, approximately 0.02 parts by mass or greater, or approximately 0.05 parts by mass or greater, and approximately 0.5 parts by mass or less, approximately 0.4 parts by mass or less, or approximately 0.3 parts by mass or less, relative to 100 parts by mass of the acrylic adhesive polymer.

Examples of the solvent include methanol, ethanol, hexane, heptane, toluene, acetone, methyl ethyl ketone, methyl isobutyl ketone, ethyl acetate, butyl acetate, and mixed solvents thereof.

Examples of other additives include UV absorbing agents, antioxidants, thermal stabilizers, fillers, and tackifiers.

The thickness of the acrylic pressure-sensitive adhesive layer is not particularly limited and, for example, can be approximately 5 μm or greater, approximately 10 μm or greater, or approximately 20 μm or greater, and approximately 200 μm or less, approximately 100 μm or less, or approximately 80 μm or less.

The adhesive film can be produced by a known method. For example, an acrylic pressure-sensitive adhesive layer is formed by coating a pressure-sensitive adhesive composition on a liner by using a knife coater or a bar coater and drying. To react the crosslinking agent which is an optional component, the acrylic pressure-sensitive adhesive layer may be heated by using hot air or an oven during the drying. On the obtained acrylic pressure-sensitive adhesive layer, a clear film layer or a laminate having a clear film layer can be layered by a method such as dry lamination, and thus an adhesive film can be produced. The adhesive film can be also produced by directly coating the pressure-sensitive adhesive composition on a clear film layer or another layer constituting a laminate having a clear film layer and drying.

The acrylic pressure-sensitive adhesive layer may be solid or may be a porous or foam body. The adhesive surface of the acrylic pressure-sensitive adhesive layer may be flat or may have recesses and protrusions. The adhesive surface with recesses and protrusions include an adhesive surface of the acrylic pressure-sensitive adhesive layer, in which the protrusions containing a solid content or reaction product of the pressure-sensitive adhesive composition and the recesses surrounding the protrusions are formed, and when the adhesive surface is attached to an adherend, a communicating passage is formed between the adherend surface and the adhesive surface, the communicating passage being defined by the recesses and being in communication with the external space. An example of the method for forming the adhesive surface with recesses and protrusions will be described below.

A liner with a release surface including a predetermined recess-and-protrusion structure is prepared. The pressure-sensitive adhesive composition is coated to the release surface of the liner, and as necessary, heated to form an acrylic pressure-sensitive adhesive layer. Thus, the recess-and-protrusion structure (negative structure) of the liner is transferred to the surface of the acrylic pressure-sensitive adhesive layer, the surface being in contact with the liner (to serve as the adhesive surface in the adhesive film), and thus an adhesive surface with recesses and protrusions including the predetermined structure (positive structure) at the adhesive surface is formed. As described above, the recesses and protrusions of the adhesive surface are designed in advance to include a groove that allows formation of the communicating passage when the protrusions adhere to the adherent body.

For the groove of the acrylic pressure-sensitive adhesive layer, as long as air bubbles are prevented from remaining when the adhesive film is applied, the groove having a consistent shape may be arranged at the adhesive surface in accordance with a regular pattern to form a regularly-patterned groove, or the groove having an indeterminate shape may be arranged to form an irregularly-patterned groove. In a case where multiple grooves are formed to be disposed substantially parallel to each other, the interval at which the grooves are disposed is preferably approximately 10 μm or greater and approximately 2000 μm or less. The depth of the grooves (distance from the adhesive surface to the bottom of the groove measured in the direction toward the substrate layer) is typically approximately 10 μm or greater, and approximately 100 μm or less. The shape of the groove is also not particularly limited, as long as the effect of the present invention is not impaired. For example, the shape of the groove may be substantially rectangular (including trapezoidal), substantially semi-circular, or substantially semi-elliptical at a cross-section of the groove in a direction perpendicular to the adhesive surface.

The adhesive strength of the adhesive film of an embodiment is approximately 2.5 N/25 mm or greater, approximately 3 N/25 mm or greater, or approximately 4 N/25 mm or greater, when measurement is performed by using an SUS304 plate as an adherend in accordance with JIS Z 0237:2009. The adhesive strength of the adhesive film is typically approximately 50 N/25 mm or less, approximately 45 N/25 mm or less, or approximately 40 N/25 mm or less. In the present disclosure, the measurement process and condition of the adhesive strength of the adhesive film refer to “2-3. Adhesive Strength C” described in Examples.

The adhesive film of the present disclosure can be used for marking on vehicles, ships, and aircraft, interior and exterior of buildings, and illuminated signs, and especially can be suitably used for applications that imparts metallic appearance to a three-dimensional surface such as a rough surface, a curved surface, or a corner portion.

### EXAMPLES

In the following examples, specific embodiments of the present disclosure will be exemplified, but the present invention is not limited to those embodiments. All ‘part’ and ‘percent’ are based on mass unless otherwise specified.

The raw materials used in the production of the adhesive film are shown in Table 1.

TABLE 1

| | | | | Molecular | | |
|---|---|---|---|---|---|---|
| | | | | weight/weight | | Solid |
| | | | Tg²⁾ | average molecular | | content |
| Name or abbreviation | Composition or description¹⁾ | Supplier | [°C] | weight (Mw) | Solvent | [mass %] |
| Tacky adhesive polymer 1 | BA-2EHA-AN-AA = 58:36:2:4 | — | −53 | 500000 | EtOAc | 33 |
| (ADH1) | | | | | | |
| Tacky adhesive polymer 2 | 2EHA-BA-AA = 64:30:6 | — | −57 | 280000 | EtOAc | 60 |
| (ADH2) | | | | | | |
| Tacky adhesive polymer 3 | 2MBA-AA = 90:10 | — | −23 | 400000 | Heptane | 40 |
| (ADH3) | | | | | | |
| Tacky adhesive polymer 4 | BA-AA = 94:6 | — | −48 | 600000 | EtOAc | 33 |
| (ADH4) | | | | | | |
| Tacky adhesive polymer 5 | IOA-MA-AA = 70:22.5:7.5 | — | −35 | 360000 | EtOAc | 40 |
| (ADH5) | | | | | | |
| Dispersant 1 (DPT 1) | MMA-BMA-DMAEMA = 60:34:6 | — | 63 | 68000 | EtOAc | 40 |
| Dispersant 2 (DPT 2) | Tinuvin (trademark) 123, piperidyl | BASF Japan Ltd. | — | 73 | — | 100 |
| | compound | (Chuo-ku, Tokyo, Japan) | | | | |
| Crosslinking agent | Bisamide-based crosslinking agent | 3M Japan Ltd. | — | — | Toluene | 5 |
| 1 (CL1) | RD1054 | (Shinagawa-ku, Tokyo, | | | | |
| | | Japan) | | | | |
| Crosslinking agent | Epoxy crosslinking agent E-5XM | Soken Chemical & | — | — | MEK | 5 |
| 2 (CL2) | (N,N,N′,N′-tetraglycidyl-1,3- | Engineering Co., Ltd. | | | | |
| | benzenedi(methanamine)) | (Toshima-ku, Tokyo, Japan) | | | | |
| Aluminum paste 1 (AP1) | TR-5060, acrylic resin coated-aluminum | Asahi Kasei Metals | — | — | MS/SN | 50 |
| | paste, volume average particle diameter | Corporation | | | | |
| | Dv 6 μm | (Chiyoda-ku, Tokyo, Japan) | | | | |
| Aluminum paste 2 (AP2) | TR-4070, acrylic resin coated-aluminum | Asahi Kasei Metals | — | — | MS/SN | 50 |
| | paste, volume average particle diameter | Corporation | | | | |
| | Dv 7 μm | (Chiyoda-ku, Tokyo, Japan) | | | | |
| Aluminum paste 3 (AP3) | TR-2100, acrylic resin coated-aluminum | Asahi Kasei Metals | — | — | MS/SN | 60 |
| | paste, volume average particle diameter | Corporation | | | | |
| | Dv 10 μm | (Chiyoda-ku, Tokyo, Japan) | | | | |
| Aluminum paste 4 (AP4) | TR-508H, acrylic resin coated-aluminum | Asahi Kasei Metals | — | — | MS/SN | 46 |
| | paste, volume average particle diameter | Corporation | | | | |
| | Dv 8 μm | (Chiyoda-ku, Tokyo, Japan) | | | | |
| Aluminum paste 5 (AP5) | TR-2130, acrylic resin coated-aluminum | Asahi Kasei Metals | — | — | MS/SN | 60 |
| | paste, volume average particle diameter | Corporation | | | | |
| | Dv 13 μm | (Chiyoda-ku, Tokyo, Japan) | | | | |
| Aluminum paste 6 (AP6) | HR-50A, acrylic resin coated-aluminum | Asahi Kasei Metals | — | — | MS/SN | 64 |
| | paste, volume average particle diameter | Corporation | | | | |
| | Dv 20 μm | (Chiyoda-ku, Tokyo, Japan) | | | | |
| Aluminum paste 7 (AP7) | HR-9901, acrylic resin coated-aluminum | Asahi Kasei Metals | — | — | MS/SN | 55 |
| | paste, volume average particle diameter | Corporation | | | | |
| | Dv 20 μm | (Chiyoda-ku, Tokyo, Japan) | | | | |
| Aluminum paste 8 (AP8) | HR-21, acrylic resin coated-aluminum | Asahi Kasei Metals | — | — | MS/SN | 61 |
| | paste, volume average particle diameter | Corporation | | | | |
| | Dv 28 um | (Chiyoda-ku, Tokyo, Japan) | | | | |
| Aluminum paste 9 (AP9) | HR-800, acrylic resin coated-aluminum | Asahi Kasei Metals | — | — | MS/SN | 61 |
| | paste, volume average particle diameter | Corporation | | | | |
| | Dv 34 μm | (Chiyoda-ku, Tokyo, Japan) | | | | |
| Aluminum paste 10 (AP10) | AL paste 54-452, aluminum paste that is | Toyo Aluminum K.K. | — | — | MS/SN | 72 |
| | not resin-coated, volume average particle | (Osaka-shi, Osaka, Japan) | | | | |
| | diameter Dv 33 μm | | | | | |
| Release liner 1 (L1) | KPM11S, polyethylene-laminated paper | Lintec Corporation | — | — | — | — |
| | liner | (Itabashi-ku, Tokyo, Japan) | | | | |
| Film 1 (FL1) | AF1900, gloss finish transparent acrylic | 3M Japan Ltd. | — | — | — | — |
| | film, thickness: 50 μm | (Shinagawa-ku, Tokyo, | | | | |
| | | Japan) | | | | |
| Film 2 (FL2) | PF901AP, matte finish transparent acrylic | 3M Japan Ltd. | — | — | — | — |
| | film, thickness: 53 μm | (Shinagawa-ku, Tokyo, | | | | |
| | | Japan) | | | | |

¹⁾BA: n-butyl acrylate, 2EHA: 2-ethylhexyl acrylate, AN: acrylonitrile, AA: acrylic acid, 2MBA: 2-methylbutyl acrylate, IOA: isooctyl acrylate, MA: methyl acrylate, MMA: methyl methacrylate, BMA: butyl methacrylate, DMAEMA: dimethylaminoethyl methacrylate, EtOAc: ethyl acetate, MEK: methyl ethyl ketone, MS: mineral spirit, SN: solvent naphtha
²⁾Value calculated by using Fox equation

### Example 1

The pressure-sensitive adhesive composition containing the adhesive polymer 1 (ADH1), dispersant 1 (DPT1), aluminum paste 1 (AP1), and crosslinking agent 1 (CL1) was prepared. The mass ratio of ADH1:DPT1:AP1:CL1 was 100:10:5:0.10 based on non-volatile content. The pressure-sensitive adhesive composition was coated on a release liner 1 (L1) by a knife coater. The coated layer was dried at 95° C. for 5 minutes. After the drying, the acrylic pressure-sensitive adhesive layer having a thickness of 30 μm was obtained. By adhering the acrylic pressure-sensitive adhesive layer and the film 1 (FL1), the acrylic pressure-sensitive adhesive layer was transferred to the FL 1, and thus an adhesive film of Example 1 was obtained.

### Example 2 to Example 27

Adhesive films of Example 2 to Example 27 were obtained by the same procedure as in Example 1 except for changing the compositions of the pressure-sensitive adhesive compositions, the thicknesses of the acrylic pressure-sensitive adhesive layers, and the films to those shown in Table 2.

### Comparative Example 1 and Comparative Example 2

Acrylic pressure-sensitive adhesive layers of Comparative Example 1 and Comparative Example 2 were formed by the same procedure as in Example 1 except for changing the compositions of the pressure-sensitive adhesive compositions to those shown in Table 2. For Comparative Example 1 and Comparative Example 2, the appearance of the acrylic pressure-sensitive adhesive layers was unsatisfactory, and thus adhesive films were not produced.

### Comparative Example 3 and Comparative Example 4

Adhesive films of Comparative Example 3 and Comparative Example 4 were obtained by the same procedure as in Example 1 except for changing the compositions of the pressure-sensitive adhesive compositions and the thicknesses of the acrylic pressure-sensitive adhesive layers to those shown in Table 2. The acrylic pressure-sensitive adhesive layer of the adhesive film of Comparative Example 4 did not contain any aluminum paste.

TABLE 2

| | Acrylic adhesive | | | | | | | | Crosslinking | | Acrylic pressure- | |
|---|---|---|---|---|---|---|---|---|---|---|---|---|
| | polymer | | Dispersant | | Aluminum pigment | | | | agent | | sensitive adhesive | Clear |
| | | [part by | | [part by | | Dv | Resin | [part by | | [part by | layer thickness | film |
| | Type | mass] | Type | mass] | Type | [μm] | coating | mass] | Type | mass] | [μm] | layer |
| Example 1 | ADH1 | 100 | DPT1 | 10 | AP1 | 6 | Yes | 5 | CL1 | 0.10 | 30 | FL1 |
| Example 2 | ADH1 | 100 | DPT1 | 10 | AP2 | 7 | Yes | 5 | CL1 | 0.10 | 30 | FL1 |
| Example 3 | ADH1 | 100 | DPT1 | 10 | AP3 | 10 | Yes | 6 | CL1 | 0.10 | 31 | FL1 |
| Example 4 | ADH1 | 100 | DPT1 | 10 | AP4 | 8 | Yes | 5 | CL1 | 0.10 | 29 | FL1 |
| Example 5 | ADH2 | 100 | DPT1 | 10 | AP5 | 13 | Yes | 6 | CL2 | 0.20 | 31 | FL1 |
| Example 6 | ADH2 | 100 | DPT1 | 10 | AP6 | 20 | Yes | 6 | CL2 | 0.20 | 32 | FL1 |
| Example 7 | ADH2 | 100 | DPT1 | 10 | AP7 | 20 | Yes | 6 | CL2 | 0.20 | 29 | FL1 |
| Example 8 | ADH2 | 100 | DPT1 | 10 | AP8 | 28 | Yes | 6 | CL2 | 0.20 | 30 | FL1 |
| Example 9 | ADH2 | 100 | DPT1 | 10 | AP8 | 28 | Yes | 6 | CL2 | 0.20 | 50 | FL1 |
| Example 10 | ADH2 | 100 | DPT1 | 10 | AP9 | 34 | Yes | 6 | CL2 | 0.20 | 54 | FL1 |
| Example 11 | ADH2 | 100 | DPT1 | 10 | AP9 | 34 | Yes | 6 | CL2 | 0.20 | 33 | FL1 |
| Example 12 | ADH2 | 100 | DPT1 | 10 | AP9 | 34 | Yes | 6 | CL2 | 0.20 | 49 | FL1 |
| Example 13 | ADH2 | 100 | DPT1 | 10 | AP5 | 13 | Yes | 6 | CL2 | 0.20 | 31 | FL2 |
| Example 14 | ADH2 | 100 | DPT1 | 10 | AP6 | 20 | Yes | 6 | CL2 | 0.20 | 32 | FL2 |
| Example 15 | ADH2 | 100 | DPT1 | 10 | AP7 | 20 | Yes | 6 | CL2 | 0.20 | 29 | FL2 |
| Example 16 | ADH2 | 100 | DPT1 | 10 | AP8 | 28 | Yes | 6 | CL2 | 0.20 | 30 | FL2 |
| Example 17 | ADH2 | 100 | DPT1 | 10 | AP8 | 28 | Yes | 6 | CL2 | 0.20 | 50 | FL2 |
| Example 18 | ADH2 | 100 | DPT1 | 10 | AP9 | 34 | Yes | 6 | CL2 | 0.20 | 54 | FL2 |
| Example 19 | ADH2 | 100 | DPT1 | 10 | AP9 | 34 | Yes | 6 | CL2 | 0.20 | 33 | FL2 |
| Example 20 | ADH2 | 100 | DPT1 | 10 | AP9 | 34 | Yes | 6 | CL2 | 0.20 | 49 | FL2 |
| Comparative | ADH1 | 100 | DPT1 | 1 | AP10 | 33 | No | 4 | CL1 | 0.20 | N.D. | — |
| Example 1 | | | | | | | | | | | | |
| Comparative | ADH1 | 100 | DPT1 | 10 | AP10 | 33 | No | 14 | CL1 | 0.20 | N.D. | — |
| Example 2 | | | | | | | | | | | | |
| Example 21 | ADH2 | 100 | DPT1 | 10 | AP9 | 34 | Yes | 20 | CL2 | 0.20 | 30 | FL1 |
| Example 22 | ADH2 | 100 | DPT1 | 10 | AP9 | 34 | Yes | 10 | CL2 | 0.20 | 43 | FL1 |
| Example 23 | ADH2 | 100 | DPT1 | 10 | AP5/AP6 | 13/20 | Yes | 3/3 | CL2 | 0.20 | 32 | FL1 |
| Example 24 | ADH2 | 100 | — | — | AP9 | 34 | Yes | 6 | CL2 | 0.20 | 40 | FL1 |
| Example 25 | ADH2 | 100 | DPT2 | 5 | AP9 | 34 | Yes | 6 | CL2 | 0.20 | 47 | FL1 |
| Comparative | ADH3 | 100 | DPT1 | 10 | AP9 | 34 | Yes | 20 | CL2 | 0.20 | 33 | FL1 |
| Example 3 | | | | | | | | | | | | |
| Example 26 | ADH4 | 100 | DPT1 | 10 | AP9 | 34 | Yes | 20 | CL2 | 0.20 | 31 | FL1 |
| Example 27 | ADH5 | 100 | DPT1 | 10 | AP9 | 34 | Yes | 20 | CL2 | 0.20 | 32 | FL1 |
| Comparative | ADH1 | 100 | DPT1 | 10 | — | — | — | — | CL1 | 0.20 | 30 | FL1 |
| Example 4 | | | | | | | | | | | | |

(N.D. is not determined)

The adhesive films were evaluated in terms of the following points:

### 1. Appearance of Acrylic Pressure-Sensitive Adhesive Layer

The appearance of acrylic pressure-sensitive adhesive layer was visually observed. The case in which aluminum pigments were well dispersed and the surface of the acrylic pressure-sensitive adhesive layer was smooth was evaluated as A. The case in which aluminum pigments were aggregated and the surface of the acrylic pressure-sensitive adhesive layer was rough was evaluated as B. The case in which aluminum pigments were not dispersed and color density was low was evaluated as C. Evaluation of A was a pass.

### 2-1. Adhesive Strength A

A test piece was produced by cutting an adhesive film into a rectangular shape with a length of 150 mm and a width of 25 mm. The test piece was adhered on a melamine-coated plate (Paltek Corporation, Hiratsuka-shi, Kanagawa, Japan) at 20° C. The adhering method was in accordance with JIS Z 0237:2009. The test piece was left at 20° C. for 48 hours. Using a tensile tester (Tensilon (trade name) universal testing machine, model: RTC-1210A, A&D Company, Limited, Toshima-ku, Tokyo, Japan), the adhesive strength (N/25 mm) at the time of performing 180 degree peeling was measured at a peeling rate of 300 mm/min at a temperature of 20° C.

### 2-2. Adhesive Strength B

A test piece was produced by cutting an adhesive film into a rectangular shape with a length of 150 mm and a width of 25 mm. The test piece was adhered on a melamine-coated plate (Paltek Corporation, Hiratsuka-shi, Kanagawa, Japan) at 20° C. The adhering method was in accordance with JIS Z 0237:2009. The test piece was subjected to heat cycle condition of from 80° C. to −30° C. for 7 times. Using a tensile tester (Tensilon (trade name) universal testing machine, model: RTC-1210A, A&D Company, Limited, Toshima-ku, Tokyo, Japan), the adhesive strength (N/25 mm) at the time of performing 180 degree peeling was measured at a peeling rate of 300 mm/min at a temperature of 20° C.

### 2-3. Adhesive Strength C

A test piece was produced by cutting an adhesive film into a rectangular shape with a length of 150 mm and a width of 25 mm. The test piece was adhered on an SUS304BA panel (Paltek Corporation, Hiratsuka-shi, Kanagawa, Japan) at 20° C. The adhering method was in accordance with JIS Z 0237:2009. The test piece was left at 20° C. for 1 minute. Using a tensile tester (Tensilon (trade name) universal testing machine, model: RTC-1210A, A&D Company, Limited, Toshima-ku, Tokyo, Japan), the adhesive strength (N/25 mm) at the time of performing 180 degree peeling was measured at a peeling rate of 300 mm/min at a temperature of 20° C.

### 3. Heat Shrinkage

A test piece was produced by cutting an adhesive film into a rectangular shape with a length of 100 mm and a width of 50 mm. The test piece was adhered on an aluminum panel in an environment at 23° C. by a roller and left for 24 hours in an environment at 23° C. On the test piece, cut in shape of cross was made by a utility knife. The test piece was then heated at 65° C. for 48 hours. After the heat aging, the shrinkage (mm) of the film was measured by a microscope, and a maximum value was recorded.

4. Appearance upon Elongation

A test piece was produced by cutting an adhesive film into a square with 50 mm side. The test piece was adhered on a stucco-coated plate (Test Materials Co., Ltd., Chiyoda-ku, Tokyo, Japan) in an environment at 23° C. The maximum surface roughness of the stucco-coated plate (height from the top portion to the bottom portion) was approximately 1.5 mm. The test piece was pressurized without being heated by using PFA-1 Rivet Brush (3M Japan Ltd., Shinagawa-ku, Tokyo, Japan). By this, the test piece was partially elongated. The appearance of the adhesive film was then visually observed. The case where no change occurred in the appearance of the test piece was evaluated as A. The case where change occurred in the appearance of the test piece was evaluated as B. Evaluation of A was a pass.

### 5. Surface Glossiness

A test piece was produced by cutting an adhesive film into a square with 50 mm side. The test piece was adhered on an aluminum panel in an environment at 23° C. By using a portable glossmeter GMX-202 (Murakami Color Research Laboratory Co., Ltd., Chuo-ku, Tokyo, Japan), 60 degree gloss on a test piece surface was measured.

### 6. Weather Resistance

A test piece was produced by cutting an adhesive film into a rectangular shape with a length of 50 mm and a width of 30 mm. The test piece was adhered to an aluminum panel having a thickness of 1 mm at room temperature by using a squeegee. By using a xenon weatherometer Ci5000 Weather-Ometer (Toyo Seiki Seisaku-sho, Ltd., Kita-ku, Tokyo, Japan), the test piece was exposed to xenon light. The test conditions were in accordance with JIS K 5600-7-7:2008. The case where no change occurred in the appearance of the test piece was evaluated as A. The case where the test piece turned yellow was evaluated as B. The case where peeling off from the aluminum panel occurred was evaluated as C. Evaluation of A was a pass.

### 7. Removability

A test piece was produced by cutting an adhesive film into a rectangular shape with a length of 150 mm and a width of 25 mm. The test piece was adhered to an aluminum panel at 20° C. The test piece was subjected to heat cycle condition of from 80° C. to −30° C. for 7 times. Using a tensile tester (Tensilon (trade name) universal testing machine, model: RTC-1210A, A&D Company, Limited, Toshima-ku, Tokyo, Japan), 180 degree peeling was performed at a peeling rate of 300 mm/min at a temperature of 20° C. The case where no residue of the acrylic pressure-sensitive adhesive layer was observed on the aluminum panel was evaluated as A. The case where separation was observed between the acrylic pressure-sensitive adhesive layer and the film was evaluated as B. The case where a residue of the acrylic pressure-sensitive adhesive layer was observed on the aluminum panel was evaluated as C.

### 8. Corrosion Resistance

A test piece was produced by cutting an adhesive film into a rectangular shape with a length of 50 mm and a width of 30 mm. The test piece was adhered to an aluminum panel having a thickness of 1 mm at room temperature by using a squeegee. By using a xenon weatherometer Ci5000 Weather-Ometer (Toyo Seiki Seisaku-sho, Ltd., Kita-ku, Tokyo, Japan), the test piece was exposed to xenon light. The test conditions were in accordance with JIS K 5600-7-7:2008. The adhesive film surface was exposed to xenon light for 500 hours. The case where no corrosion was observed in the test piece was evaluated as A. The case where corrosion was observed in the test piece was evaluated as B. Evaluation of A was a pass.

The evaluation results of the adhesive films of Example 1 to Example 27 and Comparative Example 1 to Comparative Example 4 are shown in Table 3.

TABLE 3

| | Acrylic | | | | | | | | | |
|---|---|---|---|---|---|---|---|---|---|---|
| | pressure- | Adhesive | Adhesive | Adhesive | | | | | | |
| | sensitive | strength A | strength B | strength C | Heat | Appearance | | | | |
| | adhesive layer | [N/25 | [N/25 | [N/25 | shrinkage | upon | Surface | Weather | | Corrosion |
| | appearance | mm] | mm] | mm] | [mm] | elongation | glossiness | resistance | Removability | resistance |
| Example 1 | A | 23 | 33 | N.D. | 0.10 | A | 119 | A | A | A |
| Example 2 | A | 24 | 34 | N.D. | 0.10 | A | 118 | A | A | A |
| Example 3 | A | 23 | 36 | N.D. | 0.10 | A | 124 | A | A | A |
| Example 4 | A | 23 | 34 | N.D. | 0.05 | A | 110 | A | A | A |
| Example 5 | A | 22 | 31 | 24 | 0.11 | A | 116 | A | A | A |
| Example 6 | A | 22 | 28 | 23 | 0.09 | A | 120 | A | A | A |
| Example 7 | A | 22 | 29 | 24 | 0.09 | A | 110 | A | A | A |
| Example 8 | A | 21 | 28 | 23 | 0.08 | A | 114 | A | A | A |
| Example 9 | A | 23 | N.D. | 27 | 0.08 | A | 110 | A | N.D. | N.D. |
| Example 10 | A | 21 | N.D. | 22 | 0.07 | A | 130 | A | N.D. | N.D. |
| Example 11 | A | 19 | 31 | 23 | 0.09 | A | 115 | A | A | A |
| Example 12 | A | 22 | 34 | 22 | 0.05 | A | 114 | A | A | A |
| Example 13 | A | N.D. | N.D. | N.D. | N.D. | A | 37 | A | N.D. | A |
| Example 14 | A | N.D. | N.D. | N.D. | N.D. | A | 38 | A | N.D. | A |
| Example 15 | A | N.D. | N.D. | N.D. | N.D. | A | 32 | A | N.D. | A |
| Example 16 | A | N.D. | N.D. | N.D. | N.D. | A | 34 | A | N.D. | A |
| Example 17 | A | N.D. | N.D. | N.D. | N.D. | A | 32 | A | N.D. | A |
| Example 18 | A | N.D. | N.D. | N.D. | N.D. | A | 37 | A | N.D. | A |
| Example 19 | A | N.D. | N.D. | N.D. | N.D. | A | 36 | A | N.D. | A |
| Example 20 | A | N.D. | N.D. | N.D. | N.D. | A | 35 | A | N.D. | A |
| Comparative | B | N.D. | N.D. | N.D. | N.D. | N.D. | N.D. | N.D. | N.D. | N.D. |
| Example 1 | | | | | | | | | | |
| Comparative | B | N.D. | N.D. | N.D. | N.D. | N.D. | N.D. | N.D. | N.D. | N.D. |
| Example 2 | | | | | | | | | | |
| Example 21 | A | 19 | 35 | 20 | 0.19 | A | 110 | A | B | A |
| Example 22 | A | 21 | 31 | 22 | 0.18 | A | 111 | A | A | A |
| Example 23 | A | 18 | 27 | 22 | 0.21 | A | 111 | A | A | A |
| Example 24 | A | 21 | 25 | 26 | 0.14 | A | 112 | A | A | A |
| Example 25 | A | 18 | 23 | 23 | 0.12 | A | 110 | A | A | A |
| Comparative | A | 7 | N.D. | 2 | 0.10 | N.D. | N.D. | N.D. | N.D. | N.D. |
| Example 3 | | | | | | | | | | |
| Example 26 | A | 18 | N.D. | 4 | 0.10 | N.D. | N.D. | N.D. | N.D. | N.D. |
| Example 27 | A | 22 | N.D. | 5 | 0.10 | N.D. | N.D. | N.D. | N.D. | N.D. |
| Comparative | N.D. | 17 | N.D. | 11 | 0.12 | N.D. | N.D. | N.D. | N.D. | N.D. |
| Example 4 | | | | | | | | | | |

(N.D. is not determined)

Various variations of the above-mentioned embodiments and examples will be apparent to those skilled in the art without departing from the basic principle of the present invention. Various improvement and modifications to the present invention can be implemented without departing from the spirit and scope of the present invention.

1. An adhesive film having a metallic appearance, the adhesive film comprising a clear film layer and an acrylic pressure-sensitive adhesive layer,
the acrylic pressure-sensitive adhesive layer comprising an acrylic adhesive polymer and a resin-coated metal pigment,
the acrylic adhesive polymer having a glass transition temperature of −25° C. or less, and
the acrylic pressure-sensitive adhesive layer containing from 5 parts by mass to 100 parts by mass of the resin-coated metal pigment relative to 100 parts by mass of the acrylic adhesive polymer.

2. The adhesive film according to claim 1, wherein the resin-coated metal pigment has an acrylic resin coating.

3. The adhesive film according to claim 1 or 2, wherein the resin-coated metal pigment contains aluminum.

4. The adhesive film according to claim 1, wherein the resin-coated metal pigment is scaly.

5. The adhesive film according to claim 1, wherein a visible light transmittance of the clear film layer is 70% or greater.

6. The adhesive film according to claim 1, wherein the adhesive film has an adhesive strength of 2.5 N/25 mm or greater when measurement is performed by using an SUS304 plate as an adherend in accordance with JIS Z 0237:2009.

7. The adhesive film according to claim 1, wherein a content of a pigment except the resin-coated metal pigment of the acrylic pressure-sensitive adhesive layer is less than 5 parts by mass relative to 100 parts by mass of the acrylic adhesive polymer.
